(19) United States
(12) Patent Application Publication
(10) Pub. No.: US 2015/0368962 A1
(43) Pub. Date: Dec. 24, 2015

(54) STORM PROTECTION SYSTEM

(71) Applicants: Stephen J. Motosko, Sarasota, FL (US); Stephen J. Motosko, III, Sarasota, FL (US); Catherine Motosko, Sarasota, FL (US)

(72) Inventors: Stephen J. Motosko, Sarasota, FL (US); Stephen J. Motosko, III, Sarasota, FL (US); Catherine Motosko, Sarasota, FL (US)

(21) Appl. No.: 14/743,331

(22) Filed: Jun. 18, 2015

Related U.S. Application Data
(60) Provisional application No. 62/103,576, filed on Jan. 15, 2015.
(60) Provisional application No. 62/013,587, filed on Jun. 18, 2014.

(51) Int. Cl. E06B 9/15; E04H 9/14

(52) U.S. Cl. CPC E06B 9/15; E04H 9/14

(57) ABSTRACT

A storm protection system for an opening of a building is provided. The system includes a pair of side rails where the pair of side rails each has a pair of offset elongated protrusions contained within a cavity of the side rails. Further, at least one slat extending between the pair of side rails, the slat adapted to connect with the pair of offset protrusions within the side rails. In most embodiments, a plurality of slats are provided to roll up when not in use. A clip is connected to a distal end of the slat, the slat adapted to directly connect to the offset elongated protrusions contained within the cavity of the side rails

### CROSS-REFERENCE TO RELATED APPLICATIONS

This application claims priority of U.S. Provisional Application 62/103,576 filed Jun. 18, 2014 and to U.S. Provisional Application 62/013,587 filed Jun. 18, 2014, the contents of both are incorporated herein by reference.

### FIELD OF THE INVENTION

The present invention relates generally to storm protection systems. More particularly, the present invention relates to a storm protection system having a roll-up cover for an opening of a building.

### BACKGROUND OF THE INVENTION

It is known in the art to provide a roll-up storm protection system over an opening of a building, such as a window. However, when rolled up, the systems are prohibitively bulky. The various slats and components of the prior known roll-up systems are bulky making it difficult to store when in a rolled-up position. Accordingly, there exists a need in the art to provide an improved roll-up storm protection system taking up less space when in a rolled-up position.

### SUMMARY OF THE INVENTION

A storm protection system for an opening of a building is provided. The system includes a pair of side rails where the pair of side rails each has a pair of offset elongated protrusions contained within a cavity of the side rails. Further, at least one slat extending between the pair of side rails, the slat adapted to connect with the pair of offset protrusions within the side rails. In most embodiments, a plurality of slats are provided to roll up when not in use. A clip is connected to a distal end of the slat, the slat adapted to directly connect to the offset elongated protrusions contained within the cavity of the side rails. In one embodiment, the side rail has a first cavity and a second cavity, the first cavity containing the pair of offset elongated protrusions, the second cavity adapted to contain a fastener to connect to the building. The offset elongated protrusions contained within the cavity of the side rails may extend into the center of the first cavity.

A cap may be adapted to cover an opening to the second cavity. A fastener is adapted to extend from the first cavity and through a portion of the cap connected to the second cavity. The cap may include an elongated leg. The screw extends through the elongated leg to further secure the elongated rail to the building.

Specifically referring to the side rail, the side rails are adapted to connect to a slat adapted to cover the opening of a building. The side rail may include a plurality of sidewalls arranged to define at least one cavity, the at least one cavity having an opening. A fastener may be positioned at least partially within the cavity, the fastener extending through one of the sidewalls to connect to the building. Further, a cap may be adapted to cover the opening to the cavity so as to hide the fastener from view.

In one embodiment, the cap includes an elongated leg, the elongated leg connected to a secondary fastener to secure the cap to the side rail. Further, a pair of offset elongated protrusions contained within the at least one cavity.

Typically, at least one slat extending between a pair of side rails. The slat is adapted to connect with the pair of offset protrusions within the side rails. At least one slat is provided to roll up when not in use, the slat adapted to connect to a pair of side rails.

A clip may be optionally connected to a distal end of the slat, the slat adapted to directly connect to the offset elongated protrusions contained within the cavity of the side rails.

In one embodiment, the side rail has a first cavity and a second cavity, the first cavity containing a pair of offset elongated protrusions, the second cavity adapted to contain a fastener to connect to the building. In some embodiments, the offset elongated protrusions contained within the cavity of the side rails extend into the center of the first cavity.

### BRIEF DESCRIPTION OF THE DRAWINGS

FIG. 1 illustrates an environmental view of the storm protection system of the present invention in an installed and rolled-down position;

FIG. 2 illustrates an exploded perspective view of the assembly of the present invention;

FIG. 3 illustrates a perspective view of the clip of the storm protection system of the present invention;

FIG. 4 illustrates an alternative perspective view of the clip of the storm protection system of the present invention;

FIG. 5 illustrates a cross-sectional view of the slat of the present invention;

FIG. 6 illustrates an alternative embodiment of the slat of the present invention;

FIG. 7 illustrates a perspective view of the clip installed on a slat when the slats are in a rolled-up position;

FIG. 8 illustrates a cross-sectional view of a side rail of the present invention;

FIG. 9 illustrates a cross-sectional view of an alternative embodiment of the side rail of the present invention;

FIG. 10 illustrates an alternative embodiment of a side rail and slat having an integrally formed clip;

FIG. 11 illustrates another embodiment of a side rail and a slat having an alternative embodiment of an integrally formed clip; and

FIG. 12 illustrates a side view of an assembly of slats connected together and in a rolled-up position.

### DETAILED DESCRIPTION OF THE INVENTION

The present system relates to a storm protection system for the opening of a building. The system includes a pair of side rails having a pair of offset elongated protrusions contained within the side rails. At least one slat extends between the pair of side rails wherein the slat is adapted to connect with the pair of offset protrusions contained within the side rails. In the present embodiment, the slats connect to the side rails by means of a clip fixedly connected to the distal ends of the slat and adapted to securely connect to the pair of offset protrusions contained within the side rails.

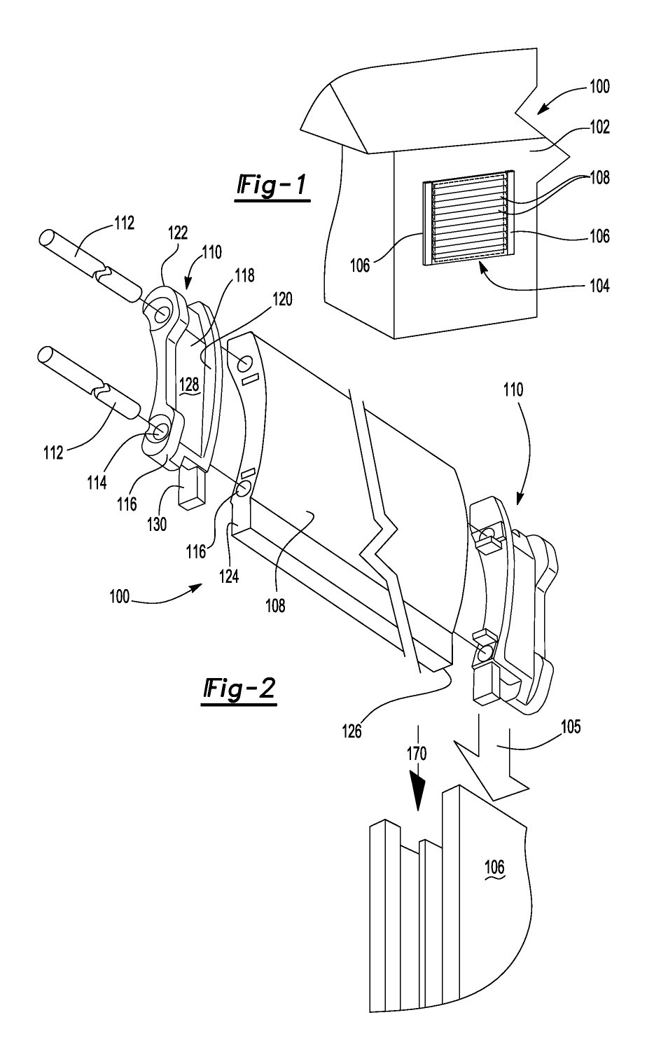

An environmental view showing the system 100 mounted on a building 102. The building 102 includes an opening, or a window 104. A pair of side rails 106 are disposed on opposite sides and generally vertically affixed to the building 102. A plurality of slats 108 connect to the side rails to cover the window 104. FIG. 1 illustrates the slats in a closed position to protect a window from storm damage. When not in use, the plurality of slats 108 roll up and are capable of being stored over the window 104.

The system 100 is further illustrated in the perspective exploded view of FIG. 2. The system generally includes a slat 108 having two clips 110 provided at either distal end of the slat 108. After installation and being rolled down, as illustrated by directional arrow 105, the clips 110 are adapted to slide into the side rails 106 and into the cavity 170 of the side rails 106.

The slat 108 includes a first distal end 124 and a second distal end 126. The distal ends 124 and 126 each include a pair of apertures 116 adapted to connect with the clip 110. The distal ends 124, 126 each include a generally planar surface to smoothly connect with the clips 110.

The clips 110 include various connection features 130, 120 allowing the clips to easily nestle on top of one another. The clips 110 further include corresponding apertures 114 to accept pins 112. The pins 112 extend through the aperture 114 and through the aperture 116 to connect the clip 110 to the slat 108. Raised portions 120, 122 encourage the clips to nest on one another when in a rolled position.

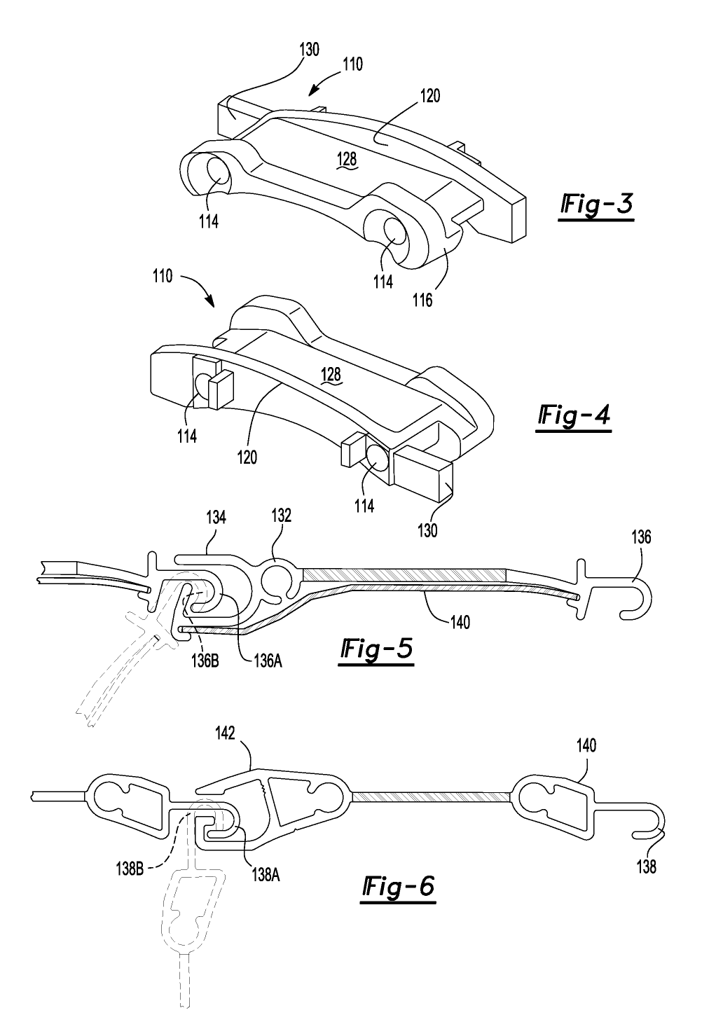

Various views of the clip 110 are illustrated in FIGS. 3 and 4. The clips further include an upper surface 128 adapted to nestle with a lower surface of the clip 110. The slats 108 are connected together by means of the connectors as illustrated in FIGS. 5 and 6. The connectors of FIGS. 5 and 6 are adapted to connect to one another based on the requirements and space constraints of the system. The connector as illustrated in FIG. 5 includes a hook portion 106 adapted to connect with a corresponding hook portion 132, 134. FIG. 5 illustrates hook portion 136 connected to the hook portion 134 in an extended position 136a and a rolled-up position 136b.

Similarly, FIG. 6 illustrates an embodiment of the connector having hook portion 138 and connector portion 140. The opposite distal end of the connector portion 142 is provided connected to the hook 138. FIG. 6 illustrates the hook in an extended position 138a and a rolled-up position 138b.

A plastic or other polymer sheet portion 140 may also be provided connected to the connector, such as illustrated in FIG. 5, to provide added strength and resiliency.

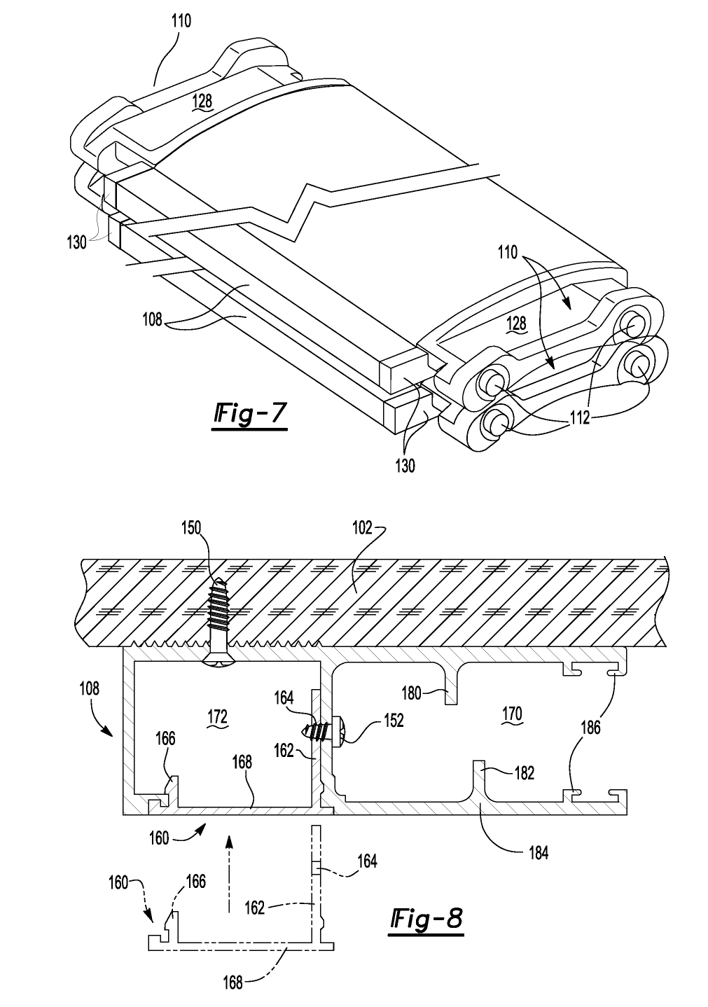

An example of the side rail 108 is illustrated in FIG. 8. The side rail is generally extruded metal, such as aluminum or steel, but may also be made from a strong plastic, plastic like, polymer, or polymer like material so long as it provides sufficient resiliency and strength during a storm. The side rail 108 includes a first cavity 170 and a second cavity 172. The first cavity 170 includes a pair of offset elongated protrusions 180, 182. The offset protrusions 180, 182 connect to elongated portion 184 also holding connecting portions 186. The offset protrusions 180, 182 allow a smaller clip 110 to be used. Prior clips are bulky thus resulting in a bulky configuration when the slats are in a rolled-up configuration. The improved thinner clips 110 of the present invention are adapted to nest and rest nicely on top of one another, such as illustrated in FIG. 7. The offset configuration of the protrusions 180, 182 allows the smaller clip to be contained within the side rail 106 while still providing for a tight configuration. Furthermore, the offset configuration of the protrusions 180, 182 allows an installer to install a screw 152, such as illustrated in FIG. 8. The screw 152 provides an added security measure in that it secures a cap 160 which covers a second cavity 172.

The second cavity 172 allows the user to secure the side rail 108 to the building 102. A screw 150 extends through a screw aperture within the cavity 172. For aesthetic and protective reasons, a cap 160 is adapted to connect and cover the cavity 172. The cap 160 includes an outer portion 168 having a clip portion 166 and an extended leg 162. The extended leg 162 includes an aperture 164 which is adapted to connect to the screw 152. The screw 152 is installed through the first cavity 170. The offset nature of the elongated protrusions 180, 182 allows an installer to more easily access the aperture 164 and install the screw 152. After the cap is installed, a thief is not able to access the screw 150. Accordingly, the cap 160 and the corresponding screw 152 provide for an additional safety and security means when the side rails and storm protection system are installed.

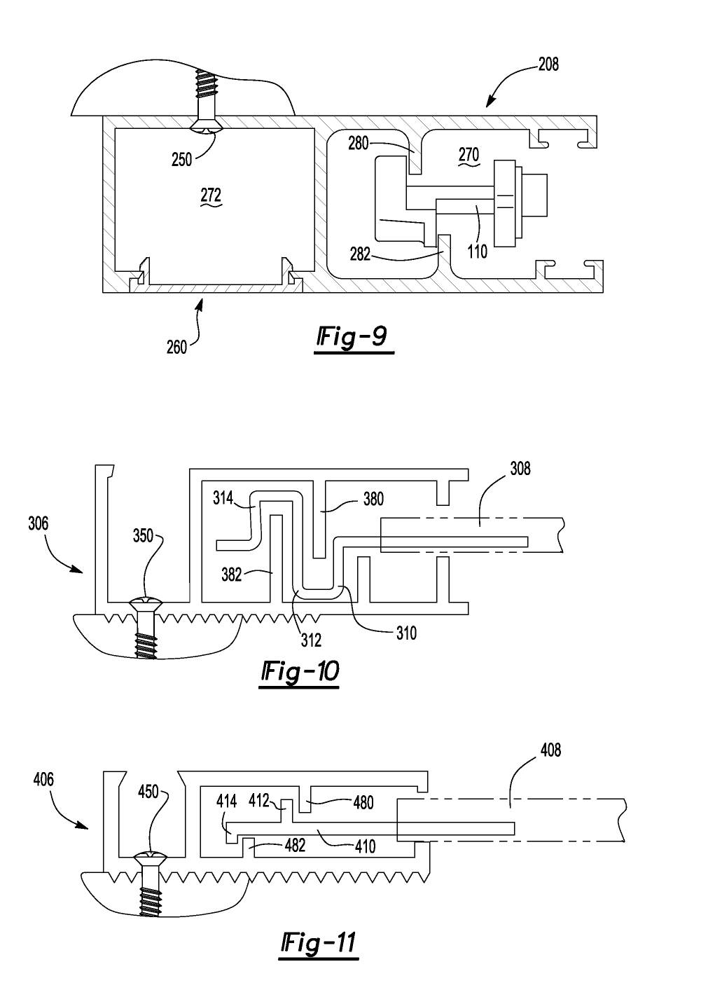

FIG. 9 illustrates an alternative embodiment of a side rail 208. The side rail 208 further includes elongated protrusions 280, 282 adapted to connect to the clip 110. Similarly, the side rail 208 includes a clip 260 having a shorter leg but still adapted to cover a second cavity 272.

In further alternative embodiments, such as illustrated in FIG. 10, a slat 308 is integrally connected with the clip portion 310. In the embodiment as illustrated in FIG. 10, the clip portion includes a plurality of bend portions 312, 314 which are adapted to connect and wind around the pair of offset protrusions 380, 382. A screw 350 may also be used to connect the side rail 306 to a building. A cap, not shown, may also be used to secure access to the screw 350. The cap may be of a similar configuration as to the caps illustrated in FIGS. 8 and 9.

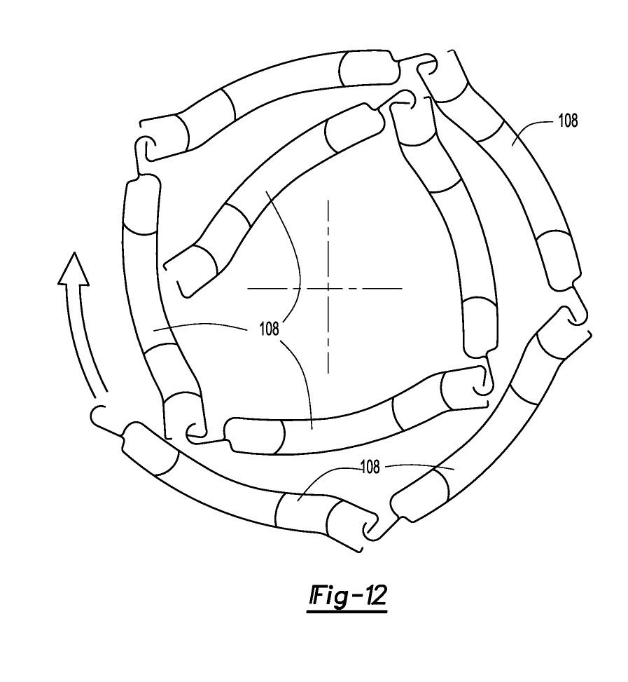

A further alternative embodiment is illustrated in FIG. 11. A slat 408 is integrally connected with a clip portion 410 having protruding portions 412, 414. The protruding portions 412, 414 are adapted to extend around and connect with the pair of elongated protrusions 480, 482. Similarly, a screw 450 is adapted to connect the side rail 406 to a building. Also, a cap similar to those shown in FIGS. 8 and 9 will also be used in this embodiment.

FIG. 12 illustrates the plurality of slats connected together and in a rolled-up position. The present embodiment with a thinner clip and offset elongated protrusions contained within the side rails allows the slats connected together to rest on top of one another thus being smaller and less bulky as compared to the prior art.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

1. A storm protection system for an opening of a building, the system comprising:
a pair of side rails, the pair of side rails each having a pair of offset elongated protrusions contained within a cavity of the side rails; and
at least one slat extending between the pair of side rails, the slat adapted to connect with the pair of offset protrusions within the side rails.

2. The storm protection system of claim 1 wherein a plurality of slats are provided to roll up when not in use.

3. The storm protection system of claim 1 wherein a clip is connected to a distal end of the slat, the slat adapted to directly connect to the offset elongated protrusions contained within the cavity of the side rails.

4. The storm protection system of claim 1 wherein the side rail has a first cavity and a second cavity, the first cavity containing the pair of offset elongated protrusions, the second cavity adapted to contain a fastener to connect to the building.

5. The storm protection system of claim 4 wherein the offset elongated protrusions contained within the cavity of the side rails extend into the center of the first cavity.

6. The storm protection system of claim 4 wherein a cap is adapted to cover an opening to the second cavity.

7. The storm protection system of claim 6 wherein a fastener is adapted to extend from the first cavity and through a portion of the cap connected to the second cavity.

8. The storm protection system of claim 6 wherein the cap includes an elongated leg.

9. The storm protection system of claim 8 wherein the screw extends through the elongated leg to further secure the elongated rail to the building.

10. A side rail for use with a storm protection system, the side rails adapted to connect to a slat adapted to cover the opening of a building, the side rail comprising:
a plurality of sidewalls arranged to define at least one cavity, the at least one cavity having an opening;
a fastener positioned at least partially within the cavity, the fastener extending through one of the sidewalls to connect to the building; and
a cap adapted to cover the opening to the cavity so as to hide the fastener from view.

11. The side rail of claim 10 wherein the cap includes an elongated leg, the elongated leg connected to a secondary fastener to secure the cap to the side rail.

12. The side rail of claim 10 wherein a pair of offset elongated protrusions contained within the at least one cavity.

13. The side rail of claim 10 wherein at least one slat extending between a pair of side rails.

14. The side rails of claim 13 wherein the slat is adapted to connect with the pair of offset protrusions within the side rails.

15. The side rail of claim 10 wherein at least one slat is provided to roll up when not in use, the slat adapted to connect to a pair of side rails.

16. The side rail of claim 15 wherein a clip is connected to a distal end of the slat, the slat adapted to directly connect to the offset elongated protrusions contained within the cavity of the side rails.

17. The side rail of claim 15 wherein the side rail has a first cavity and a second cavity, the first cavity containing a pair of offset elongated protrusions, the second cavity adapted to contain a fastener to connect to the building.

18. The side rail of claim 17 wherein the offset elongated protrusions contained within the cavity of the side rails extend into the center of the first cavity.

19. The side rail of claim 10 wherein the side rail includes a jagged portion to better connect to the building.
